(19) United States
(12) Patent Application Publication
(10) Pub. No.: US 2013/0156501 A1
(43) Pub. Date: Jun. 20, 2013

(54) REINFORCED FIBER MATS FOR USE IN PAVED SURFACES

(71) Applicant: WILLIAM SCOTT HEMPHILL, Wilmington, DE (US)

(72) Inventor: WILLIAM SCOTT HEMPHILL, Wilmington, DE (US)

(21) Appl. No.: 13/713,418

(22) Filed: Dec. 13, 2012

Related U.S. Application Data
(60) Provisional application No. 61/576,484, filed on Dec. 16, 2011.

(51) Int. Cl. E01C 11/00; B32B 5/06; B32B 5/12

(52) U.S. Cl. CPC E01C 11/005; B32B 5/12; B32B 5/06
USPC 404/75; 428/113; 428/221; 442/330

(57) ABSTRACT

A reinforcement mat that can be used to improve the durability and life of an asphalt paved surface. The reinforcement mat is partially or fully coated with a resin. The resin generally has a cure temperature in excess of about 140° F.

The present invention claims priority on U.S. Provisional Patent Application Ser. No. 61/576,484 filed Dec. 16, 2011, which is incorporated herein by reference.

The present invention is directed to surface reinforcement systems, more particularly to road surface reinforcement systems, and even more particularly to road surface reinforcement systems that include the use of a reinforced fiber mat. The present invention is particularly applicable for use with paved surfaces such as, but not limited to, roads, parking lots, sidewalks, jogging and bike paths, etc. The present invention includes the use of reinforced fiber mats to provide increased benefit to the asphalt paved surface.

### BACKGROUND OF THE INVENTION

Asphalt paved surfaces are typically constructed of one or more layers of asphalt paving material placed over a graded stone sub base. The strength and durability of the paved surface is extremely dependent on the stability of the sub base material as the asphalt paving does not have the rigidity and stiffness to span over very large areas of softness or voids. This inherent flexibility, while at times a positive, is most of the time a detriment. Slight amounts of movement in the sub base allow for cracks to form in the asphalt paving surface.

Due to the effects of weather, traffic and other environmental issues, the paved surface begins to flex more than it can withstand and cracks begin to develop in the asphalt surface. These cracks then allow water to penetrate the asphalt paving and cause further deterioration through freeze thaw and the development of hydraulic pressure as vehicular traffic passes over it. These mechanisms result in a shortened life time of the asphalt paving.

The fact that the asphalt paving is typically placed over either an existing concrete or previously paved surface results in another mode of failure due to lack of adhesion to the substrate. Typically a “tack coat” of a hot or cold applied asphaltic emulsion is sprayed onto the existing layer. The hot asphalt is then laid down over this sticky liquid layer. The result is a bond between the new asphalt layer and the existing substrate that is generally very weak. Traffic, thermal expansion and contraction as well as differential bending of the layers induce significant shear loads at the bond line. These bond line failures exacerbate the cracking failures and further shorten the paving life span of the asphalt paving.

The typical way of repairing this damaged asphalt is to apply an additional layer of asphalt paving over the existing asphalt layer that is cracking or failing. Alternatively, a “pot hole” is often just filled in with a new layer of asphalt paving. Since neither of these methodologies fixes the underlying cause of the failure, the pavement often fails directly over the existing cracks or bad area. Over the years, many ways have been tried to address these inadequacies in asphalt paving.

One method attempted is to reinforce the pavement itself This method has been done through various combinations of chemical additives and alternate filler materials. The use of fibers added directly to the asphalt paving matrix has been tried both as fibers and as woven glass fabric as far back as 1938 as described in U.S. Pat. No. 2,115,667, which is incorporated herein by reference. This method for reinforcing the asphalt paving did not prove very successful as the woven mat trapped the water in the paving. In general, due to the physical properties of the asphalt paving, the ability to reinforce the asphalt paving has been of limited commercial success.

Another method that has been used to reinforce asphalt paving involves the use of a geo-textile material that is placed between the asphalt paving and the subsurface material (stone, soil or existing asphalt paving). These geo-textiles are comprised of various layers of woven and nonwoven polypropylene. The polypropylene is very efficient at wicking water away from the layer of asphalt paving and provides some reinforcement and limited crack bridging abilities. The Mirapave 400 material described in U.S. Pat. No. 7,207,744 embodies this approach. Because the asphalt paving is applied at temperatures above 300° F., the polypropylene melts and bonds to the asphalt as it cools. Unfortunately, the polypropylene mat tends to melt and/or shrink when it is exposed to the hot paving material, which detracts from its ability to provide reinforcement and waterproofing. This problem has been overcome by some manufacturers by adding a layer of glass reinforcing to the polypropylene mat. The glass reinforcing has been utilized in various configurations including mats, fabrics and individual strands both alone and in combination with the polypropylene mat. U.S. Pat. No. 6,648,547, which is incorporated by reference, illustrates and discloses one example of these reinforcement mats. The material used in the reinforcement mat is still susceptible to shrinkage upon cooling and slippage during application. Additionally, these fiber reinforced polypropylene mats add no structural capacity to the asphalt paving.

U.S. Pat. No. 6,235,136, which is incorporated by reference, discloses a water-resistant mastic membrane. The membrane comprises a carrier layer and a grid of glass fibers, both embedded in molten mastic material which then cools and forms a solid membrane. The membrane is bulky, having a thickness of 50 mm to 150 mm, and consists primarily of mastic material. The mastic becomes molten from the heat of the asphalt and melts away during application of the asphalt and helps bond the mat to the asphalt paving. The mat in this instance still is flexible and does not offer significant support after installation.

What becomes clear to one versed in the art is the need for a mat that can be used to reinforce asphalt pavement that encompasses all of the best attributes of the current art.

### SUMMARY OF THE INVENTION

The present invention relates to a reinforcement mat that can be used with a paved surface to provide structural support to the paved surface, which can facilitate in forming a strong bond between the paved surface and the sub base, and which wicks water from the paved surface.

In one non-limiting aspect of the present invention, the reinforcement mat of the present invention includes a grid of fibers. Many different types of materials that can be used to form the fibers can be used to form the reinforcement mat. The reinforcement mat can be formed of the same or different compositional type of fibers. The fibers in the reinforcement mat can have the same or differently sized and/or shaped cross-sectional area. The fibers in the reinforcement mat can have the same or different color. In one non-limiting embodiment of the invention, the fibers can include materials such as, but not limited to, glass fibers (e.g., silica glass, aramid glass, etc.), carbon fibers, quartz fibers, Kevlar® fibers, boron fibers, polyethylene fibers, polyamide fibers, polypropylene fibers, etc. The fibers can be formed of a single material or be a hybrid of one or more materials. In another and/or additional non-limiting embodiment of the invention, a majority of the fibers in the reinforcement mat are non-woven fibers. In still another and/or additional non-limiting embodiment of the invention, a majority of the fibers in the reinforcement mat are woven fibers such as, but not limited to a roving of fibers. In yet another and/or additional non-limiting embodiment of the invention, several sets of fibers are oriented together and then at least partially secured in position relative to one another to form the reinforcement mat. In one non-limiting aspect of this embodiment, the reinforcement mat if formed of at least two layers of fiber material. Each layer of fiber material is formed of a plurality of fibers or a plurality of sets of fibers. The shape, size, color and/or composition of the fibers or the fibers in each set of fibers of each layer of fiber material can be the same or different. In one non-limiting design, the shape, size and composition of a majority of the fibers or the fibers in each set of fibers of each layer of fiber material are substantially the same. In another and/or additional non-limiting design, a majority of the fibers or the fibers in each set of fibers of each layer of fiber material are non-woven fibers (e.g., laid fibers, etc.). In still another and/or additional non-limiting design, a majority of the fibers or the fibers in each set of fibers of each layer of fiber material are woven fibers. In yet another and/or additional non-limiting design, at least a portion of the fibers or the fibers in each set of fibers of each layer of fiber material are non-woven fibers and at least a portion of the fibers are non-woven fibers. For instance, the core of a set of fibers could be woven or non-woven fibers and the outer region of the set of fibers could be formed of non-woven or woven fibers.

The reinforcement mat includes at least two layers of fiber material wherein at least one layer of fiber material includes a plurality of fibers or a plurality of fiber sets that are laid in a generally parallel relationship to one another. The at least one layer of fiber material can be formed from a plurality of fibers or fiber sets wherein the plurality of fiber or fibers sets are spaced next to one another, overlap one another, or are spaced apart from one another. When the at least one layer of fiber material is formed by a plurality of fiber sets, each fiber set generally has the same number of fibers; however, this is not required. The number of fibers in a fiber set generally is about 2-500000, and typically about 5-10000, and more typically about 10-1000; however, other numbers of fibers in a fiber set can be used. Typically the fiber set includes a plurality of layers of fibers; however, this is not required. The thickness of at least one fiber set is generally at least about 0.05 mm, and typically at least about 0.1 mm; however, other thicknesses can be used. The width of a fiber set is generally greater than the thickness of the fiber set; however, this is not required. Typically the width of at least one fiber set is at least about 0.5 mm, and more typically at least about 1 mm; however, other widths can be used. As can be appreciated, when one or more of the layers of fiber material are formed of fibers, the fibers can have the same or difference sizes as the fabric sets as described above. When a plurality of fibers or fiber sets are spaced apart from one another, the fibers or fiber sets are spaced at generally the same distance apart from one another; however, this is not required. Each fiber or set of fibers is generally formed of the same material; however, this is not required. As can be appreciated, each fiber or set of fibers can be formed of the same type of material or the same mixture of materials, however, this is not required.

The reinforcement mat includes at least layers of fiber material. At least two of the layers of fiber material are laid in a non-parallel relationship to one another. The fibers in each layers of fiber material can be the same or different material. Each layer of fiber material can have the same number of fibers or fiber sets; however, this is not required. When two or more layers of fiber material are positioned in a non-parallel relationship to one another, one layer of fiber material has an angular orientation to another layer of fiber material of about 10-90°. In one non-limiting design of this aspect, the one layer of fiber material is laid at least partially on another layer of fiber material so as to form an angular orientation that is generally perpendicular. As can be appreciated, more than two layers of fiber material can be used to form the reinforced fabric. These layers of fiber material can be positioned parallel or non-parallel to one another. For instance, when the reinforcement mat is formed of three layers of fiber material, none of the layers of fiber material are positioned parallel to one another. In one non limiting orientation of three layers of fiber material, the first and second layers of fiber material are oriented 70-90° to one another and the third layers of fiber material is oriented at about 20-60° relative to the first and second layers of fiber material. As can be appreciated, many other orientations of the three layers of fiber material can be used. As can also be appreciated, more than three layers of fiber material can be used to form the reinforcement mat.

The reinforcement mat is formed by a plurality of fiber or fiber sets that are at least partially held together and at least partially held in position by one or more stitched or knitted threads, woven together, and/or by a melted bond. As defined hereinafter, any reference to “stitch”, “stitching” or “stitched” will broadly refer to any type of stitching, knitting, knotting, and/or crocheting technique. The one or more threads, when used, are used to at least partially maintain the relative position of the fiber sets in one or more layers of fiber material and are looped about one or more fiber sets such that a portion of the thread forms a substantially closed loop about one or more fiber sets. The intersecting portion of the thread can be least partially fused together by radiation and/or heat; however, this is not required. In one non-limiting embodiment, the fibers or fibers sets of a layer of fabric material are at least partially held together by stitching and/or by being woven together. In another non-limiting embodiment, a plurality of layers of fiber material are at least partially held together by stitching, adhesive, melted bond and/or by being woven together.

In another non-limiting aspect of the present invention, the reinforcement mat can be partially or fully impregnated with one or more coatings of a polymer material to form a reinforced composite material. Many types of polymer coatings can be used to at least partially impregnate the reinforcement mat. Such polymer coatings include, but are not limited to, bitumen, asphalt, tar, various types of resins, various types of resin epoxies, polyester, polypropylene, polyethylene, polyurethane, polyacrylate, and copolymers thereof. The one or more polymer coatings can be used to partially or fully impregnate all or only a portion of the reinforcement mat. The one or more polymer coatings are typically applied to the reinforcement mat by a dipping process and/or a spray coating process; however, other or additional coating processes can be used. In one non-limiting embodiment of the present invention, the reinforcement mat is partially or fully saturated or pre-impregnated with a coating that is fully or partially formed of a catalyzed resin (e.g., epoxy resin, etc.). The fibers or fiber sets used in the reinforced mat generally include glass fibers, carbon fibers, aramid fibers and some combination thereof. As can be appreciated, other or additional fibers can be used. The resin impregnated mat is generally flexible and can easily be rolled for storage and transport and then unrolled and applied to a substrate such as existing paving. The coating on the reinforcement mat can be limited to the fibers or can for a continuous layer on the reinforcement mat. In one non-limiting design, the coating on the reinforcement mat is limited to the fibers on the reinforcement mat such that a continuous layer of coating is included on the reinforcement mat after the coating is applied to the fibers of the reinforcement mat. The application of the coated reinforcement mat of the present invention to existing paving can be easier than other types of mats in that the reinforcement mat of the present invention is less prone to bunching up and blowing around when being applied to the existing paving. Additionally, the pre-impregnated reinforcement mat has an inherent tackiness to it which allows it to adhere to existing substrates without the use of liquid mastic, thus resulting in less mess and manpower during the initial laying of the reinforcement mat onto a pavement.

In still another non-limiting aspect of the present invention, the coating that can be applied to the fibers in the reinforcement mat generally includes a resin (e.g., epoxy resin, etc.) that typically has a cure temperature in excess of about 140° F. and up to about 400° F. When the reinforcement mat of the present invention is applied over an existing sub base, the reinforcement mat is generally flexible and provides reinforcement to the asphalt or bitumen material paving that is subsequently applied to the top of the reinforcement mat. Once the reinforcement mat is applied to a sub base, a layer of hot asphalt or bitumen material paving is then applied over the reinforcement mat. The manner in which the asphalt or bitumen material paving is applied over the reinforcement mat of the present invention can be the same or similar as the manner in which the asphalt paving is applied over prior art mats. The combination of the heat of the asphalt or bitumen material paving and the pressure from the rollers as the asphalt or bitumen material is applied to the top of the reinforcement mat causes the pre-impregnated resin (e.g., epoxy resin, etc.) to a) become less viscous and flow into the asphalt, bitumen material, bitumen material-concrete matrix, or asphalt-concrete matrix to facilitate in the bonding of the reinforcement mat to the asphalt, bitumen material, bitumen material-concrete matrix, or asphalt-concrete matrix that is being applied to the top of the reinforcement mat, b) saturate the fibers of the fiber reinforcement mat and/or c) facilitate in the bonding of the reinforcement mat to the sub base. At the same time that heat and pressure is being applied to the reinforcement mat of the present invention, the cure cycle of the epoxy is initiated and thereafter is quickly completed. The result of the flowing and curing of the resin in the reinforcement mat of the present invention creates a structural reinforcement that is fully bonded to the asphalt or bitumen material paving and the sub base. The use of the reinforcement mat of the present invention can add significant structural and life cycle properties to the asphalt or bitumen material paving.

In yet another non-limiting aspect of the present invention, the thickness of the coating on the fibers or fiber sets of the reinforcement mat is generally at least about 0.05 mm thick and up to about 50 mm; however, other thicknesses can be used. The ratio of the thickness of the coating (e.g., resin, etc.) to the thickness of the fibers or fiber sets of the reinforcement mat is generally about 0.1-50:1, typically about 0.2-25:1, more typically about 0.25-10:1, and yet more typically about 0.3-5:1. In one non-limiting design the thickness of the resin is greater than the thickness of the fibers or fiber sets of the reinforcement mat. In another non-limiting design the thickness of the resin is less than the thickness of the fibers or fiber sets of the reinforcement mat.

In still yet another non-limiting aspect of the present invention, the fibers or the fibers that form the fiber sets that can be used in the reinforcement mat of the present invention include carbon, aramid or basalt, glass, etc.

In another non-limiting aspect of the present invention, the reinforcement mat of the present invention can be fabricated using any methodology including weaving or adhesive bonding and/or stitching.

In still another non-limiting aspect of the present invention, the spacing of the tows in the reinforcement mat of the present invention can be any distance. Generally the spacing is about 0.2 inches to about 4 inches, depending on the final application.

In yet another non-limiting aspect of the present invention, the reinforcement mat of the present invention can be fabricated with the fiber tows (i.e., fibers or fiber sets) oriented in the 0°, the 90° direction, any angle from 0° to 180° or any combination of those angles. In one non-limiting embodiment, the reinforcement mat of the present invention has fiber tows oriented 90° relative to adjacently positioned tows.

In still yet another non-limiting aspect of the present invention, the reinforcement mat of the present invention can include one or more layers of nonwoven material that is applied as a backing. The layer of nonwoven material can have a generally uniform thickness along the longitudinal length of the nonwoven material; however, this is not required. The layer of nonwoven material can be connected to the fibers or fibers sets of the reinforcement mat by stitching, adhesive bonding, melted or fused connection, use of one or more coatings, etc. The nonwoven material can have a melting point that is less than the melting point of the fibers or fibers set; however, this is not required. In one non-limiting aspect of this embodiment, the nonwoven material is formed of a polymer material that includes a material such as, but not limited to, nylon, polyester, polypropylene, polyethylene, polyurethane, poly(meth)acrylate, etc. In another and/or additional non-limiting embodiment of the invention, the nonwoven material is formed of a plurality of materials.

In another non-limiting aspect of the present invention, the resin can be any thermo-set or thermoplastic including epoxy, polyester, vinyl ester and PEET. In one non-limiting embodiment, the resin is an epoxy resin.

In still another non-limiting aspect of the present invention, the resin can be pre-applied to the fibers or fibers sets of the reinforcement mat prior to construction of the complete alignment and connection of the fibers or fibers sets or after the complete alignment and connection of the fibers or fibers sets. In one non-limiting embodiment, the resin is applied after complete alignment and connection of the fibers or fibers sets. The resin can be applied to the fibers or fibers sets in liquid and/or powder form. In one non-limiting embodiment, the resin is applied to the fibers or fibers sets in liquid form. The resin can be applied to the fibers or fibers sets either un-catalyzed or catalyzed. In one non-limiting embodiment, the resin is a pre-catalyzed resin when applied to the fibers or fibers sets.

It is one non-limiting object of the present invention to provide an improved reinforcement mat for the repair of pavement.

It is another non-limiting object of the present invention to provide an improved reinforcement mat that includes a fiber mat and a resin coating.

It is still another non-limiting object of the present invention to provide an improved reinforcement mat that includes a fiber mat and a pre-catalyzed resin coating.

It is yet another non-limiting object of the present invention to provide an improved reinforcement mat that includes a fiber mat and a resin coating and a non-woven backing.

These and other advantages will become apparent to those skilled in the art upon the reading and following of this description taken together with the accompanying drawings.

### BRIEF DESCRIPTION OF THE DRAWINGS

Reference may now be made to the drawings, which illustrates non-limiting embodiments that the invention may take in physical form and in certain parts and arrangements of parts wherein:

FIG. 1 is a front elevation sectional view of the reinforcement mat of the present invention positioned between an asphalt, bitumen material, bitumen material-concrete matrix, or asphalt-concrete matrix layer and a sub base;

FIG. 2 is a cross-section view of reinforcement mat of the present invention being positioned between an asphalt, bitumen material, bitumen material-concrete matrix, or asphalt-concrete matrix and a sub base and then compressed between the asphalt or bitumen material layer and a sub base;

FIG. 3 is a top view of one non-limiting arrangement of the reinforcement mat of the present invention;

FIG. 4 is a top view of another non-limiting arrangement of the reinforcement mat of the present invention;

FIG. 5 is an enlarged cross-sectional view of the reinforcement mat of the present invention positioned between an asphalt, bitumen material, bitumen material-concrete matrix, or asphalt-concrete matrix layer and a sub base prior to being compressed between the asphalt layer and a sub base;

FIG. 6 is an enlarged cross-sectional view of the reinforcement mat of the present invention positioned between an asphalt, bitumen material, bitumen material-concrete matrix, or asphalt-concrete matrix layer and a sub base after being compressed between the asphalt layer and a sub base; and,

FIG. 7 is front elevation view of another non-limiting arrangement of the reinforcement mat of the present invention that includes a fabric backing.

### DETAILED DESCRIPTION OF THE INVENTION

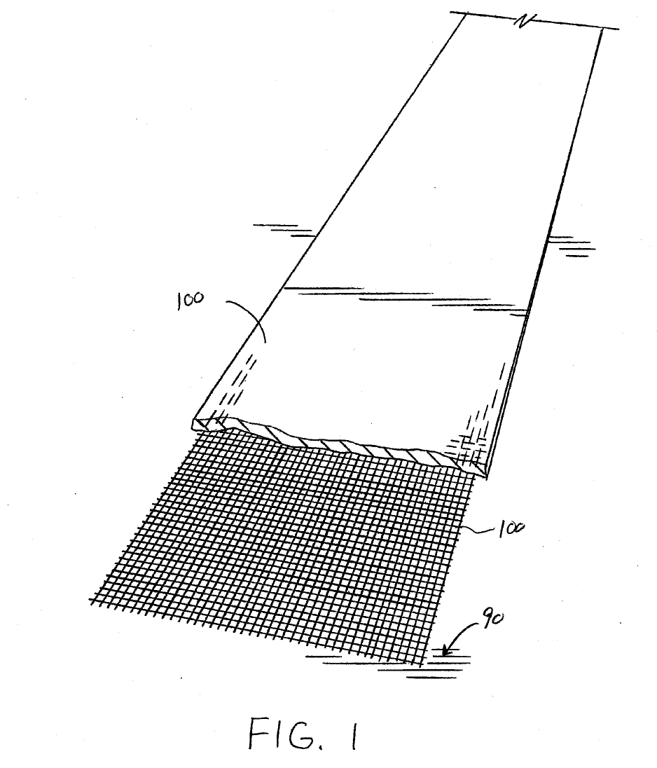

Referring now to the drawings wherein the showing is for the purpose of illustrating a non-limiting embodiment of the invention only and not for the purpose of limiting the same, FIGS. 1-7, there is illustrated a novel reinforcement mat 10 of the present invention that can be used to repair and/or reinforce various surfaces such as, but not limited to, roads, sidewalks, trails, race tracks, and any other surface over which a vehicle, bicycle, motorcycle, ATV, and the like travels over.

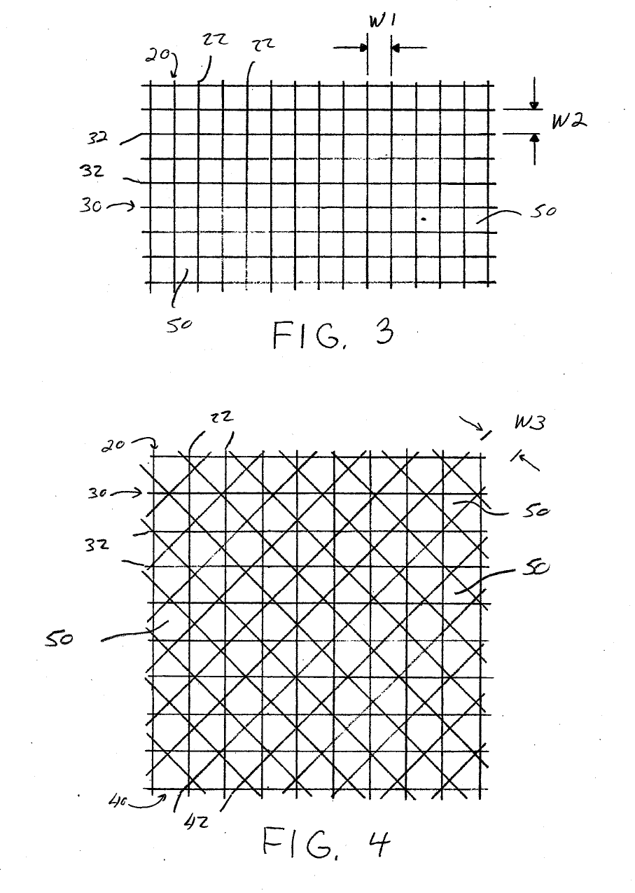

Referring now to FIGS. 3-4, there are illustrated two non-limiting fiber or fiber set patterns that can be used to form the novel reinforcement mat 10 of the present invention. As illustrated in FIG. 3, two fiber layers 20, 30 are used for the reinforcement mat. Each fiber layer includes a plurality of fibers or fiber sets.

A first fiber layer 20 includes a plurality of fibers or fiber sets 22 that are spaced apart a distance W1. The spacing of the plurality of fibers or fiber sets 22 can be constant or vary over the width of the first fiber layer 20. Generally the spacing of the plurality of fibers or fiber sets 22 is generally constant over the width of the first fiber layer 20. Distance W1 is generally about 0.1-10 inches, typically 0.25-6 inches, and more typically about 0.4-4 inches; however, other distances can be used. The total width of which is generally the width of the reinforcement mat, and such width can be about 0.1-100 ft., typically 0.5-50 ft., and more typically about 2-20 ft.; however, other total widths of the reinforcement mat can be used. The plurality of fibers or fiber sets 22 is generally arranged parallel to one another; however, this is not required. The plurality of fibers or fiber sets 22 run along the longitudinal length of the reinforcement mat and are generally equal to the longitudinal length of the reinforcement mat. The longitudinal length of the reinforcement mat is non-limiting, (e.g., 1-5000 ft., etc.). The first fiber layer 20 can be formed of a plurality of fibers and/or a plurality of fiber sets 22. For instance, fiber 22 can be formed of a single fiber. Alternatively, the fiber set can be formed of a plurality of fibers. Generally, the fibers that form the fiber set are connected together by stitching, adhesive, twisting together, etc.; however, this is not required. The fibers and/or the fibers in the fibers sets that are used in the first fiber layer 20 can be formed of the same or different material. The number of fibers that form a plurality of fiber sets can be the same or different. The number of fibers that form a plurality of fiber sets is non-limiting. The thickness of the fibers or the fibers included in a fiber set or a plurality of fiber sets can be the same or different. The thickness of a plurality of fibers sets can be the same or different. The thickness of the fibers or the fibers that form a fiber set is non-limiting. The shape of the fibers or the fibers included in a fiber set or a plurality of fiber sets can be the same or different. The color of fibers or the fibers included in a fiber set or a plurality of fiber sets can be the same or different. The strength and/or other physical properties (e.g., melting temperature, flexibility, etc.) of the fibers or the fibers included in a fiber set or a plurality of fiber sets can be the same or different. Generally, the plurality of fibers or fiber sets 22 are formed from glass fibers, carbon fibers, basalt fibers and/or aramid fibers.

A second fiber layer 30 includes a plurality of fibers or fiber sets 32 that are spaced apart a distance W2. The spacing of the plurality of fibers or fiber sets 32 can be constant or vary over the width of the second fiber layer 30. Generally the spacing of the plurality of fibers or fiber sets 32 is generally constant over the width of the second fiber layer 30. Distance W2 is generally about 0.1-10 inches, typically 0.25-6 inches, and more typically about 0.4-4 inches; however, other distances can be used. The total width is generally the longitudinal length of the reinforcement mat, and such width is non-limiting. The plurality of fibers or fiber sets 32 is generally arranged parallel to one another; however, this is not required. The plurality of fibers or fiber sets 32 run along the width of the reinforcement mat and are generally equal to the width of the reinforcement mat. The second fiber layer 30 can be formed of a plurality of fibers and/or a plurality of fiber sets 32. For instance, fiber 32 can be formed of a single fiber. Alternatively, the fiber set can be formed of a plurality of fibers. Generally, the fibers that form the fiber set are connected together by stitching, adhesive, twisting together, etc.; however, this is not required. The fibers and/or the fibers in the fibers sets that are used to the for the second fiber layer 30 can be formed of the same or different material. The number of fibers that form a plurality of fiber sets can be the same or different. The number of fibers that form a plurality of fiber sets is non-limiting. The thickness of the fibers or the fibers included in a fiber set or a plurality of fiber sets can be the same or different. The thickness of a plurality of fibers sets can be the same or different. The thickness of the fibers or the fibers that form a fiber set is non-limiting. The shape of the fibers or the fibers included in a fiber set or a plurality of fiber sets can be the same or different. The color of fibers or the fibers included in a fiber set or a plurality of fiber sets can be the same or different. The strength and/or other physical properties (e.g., melting temperature, flexibility, etc.) of the fibers or the fibers included in a fiber set or a plurality of fiber sets can be the same or different. Generally, the plurality of fibers or fiber sets 32 are formed from glass fibers, carbon fibers, basalt fibers and/or aramid fibers. The spacing W1 and W2 can be the same or different. Generally, spacing W1 and W2 is the same. The orientation of fibers or fiber sets 22 to fibers or fiber sets 32 is a non-parallel relationship. Generally, the angular relationship of fibers or fiber sets 22 to fibers or fiber sets 32 is 10-90°; typically 45-90°, and more typically about 80-90°. As illustrated in FIG. 3, the angular relationship of fibers or fiber sets 22 to fibers or fiber sets 32 is about 90°.

Referring now to FIG. 4, the reinforcement mat includes first, second and third fiber layers. Fiber layers 20 and 30 can be the same as the fibers layers described above with reference to FIG. 3; however, this is not required. The third fiber layer 40 includes a plurality of fibers or fiber sets 42 that are spaced apart a distance W3. The spacing of the plurality of fibers or fiber sets 42 can be constant or vary over the width of the third fiber layer 40. Generally the spacing of the plurality of fibers or fiber sets 42 is generally constant over the width of the third fiber layer 40. Distance W3 is generally about 0.1-10 inches, typically 0.25-6 inches, and more typically about 0.4-4 inches; however, other distances can be used. The plurality of fibers or fiber sets 42 is generally arrangement parallel to one another; however, this is not required. The third fiber layer 40 can be formed of plurality of fibers and/or a plurality of fiber sets 42. For instance, fiber 42 can be formed of a single fiber. Alternatively, the fiber set can be formed of a plurality of fibers. Generally, the fibers that form the fiber set are connected together by stitching, adhesive, twisting together, etc.; however, this is not required. The fibers and/or the fibers in the fibers sets that are used to the for the third fiber layer 40 can be formed of the same or different material. The number of fibers that form a plurality of fiber sets can be the same or different. The number of fibers that form a plurality of fiber sets is non-limiting. The thickness of the fibers or the fibers included in a fiber set or a plurality of fiber sets can be the same or different. The thickness of a plurality of fibers sets can be the same or different. The thickness of the fibers or the fibers that form a fiber set is non-limiting. The shape of the fibers or the fibers included in a fiber set or a plurality of fiber sets can be the same or different. The color of fibers or the fibers included in a fiber set or a plurality of fiber sets can be the same or different. The strength and/or other physical properties (e.g., melting temperature, flexibility, etc.) of the fibers or the fibers included in a fiber set or a plurality of fiber sets can be the same or different. Generally, the plurality of fibers or fiber sets 42 are formed from glass fibers, carbon fibers, basalt fibers and/or aramid fibers. The spacing W1, W2 and W3 can be the same or different. Generally, spacing W1, W2 and W3 is the same. The orientation of fibers or fiber sets 42 to fibers or fiber sets 22, 32 is a non-parallel relationship. Generally, the angular relationship of fibers or fiber sets 42 to fibers or fiber sets 22, 32 is 5-80°, typically 10-75°, and more typically about 15-60°. As illustrated in FIG. 4, the angular relationship of fibers or fiber sets 42 to fibers or fiber sets 22, 32 is about 45°. As can be appreciated, reinforcement mat 10 can include more than three fabric layers.

The fabric layers illustrated in FIGS. 3 and 4 are generally connected together. The type of connection arrangement is non-limiting. Such connection arrangements include, but are not limited to, a woven connection, a stitched connection, an adhesive connection, a melted bond, and the like.

As illustrated in FIGS. 3 and 4, there are a plurality of openings 50 formed between fibers or fiber sets 22, 32 or fibers or fiber sets 22, 32, 42. A plurality or all of openings 50 generally have a cross-section area that is the same as or greater than a cross-sectional area of at least one set of fibers or fiber sets 22, 32, or at least one of fibers or fiber sets 22, 32, 42. Generally the size ratio of the cross-sectional area of a plurality of openings 50 to a cross-sectional area of at least one set of fibers or fiber sets 22, 32, or at least one set of fibers or fiber sets 22, 32, 42 is at least about 1:1, typically at least about 1.1:1, more typically at least about 2:1, and still more typically at least about 5:1.

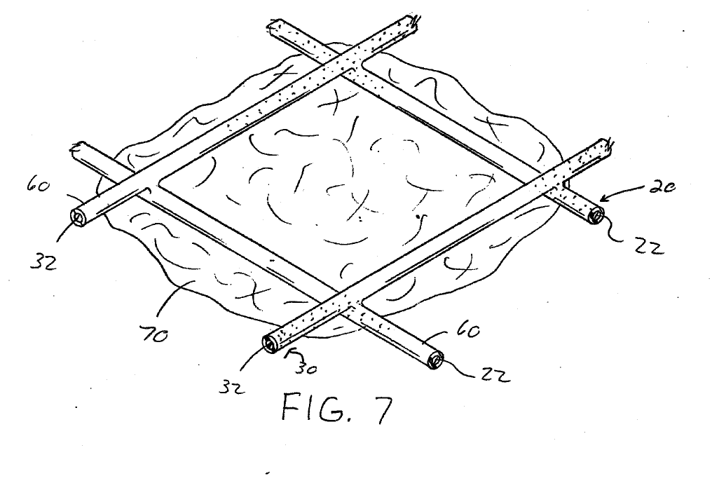

Referring now to FIG. 7, there is illustrated an enlarged portion of reinforcement mat 10 formed of two fabric layers 20 and 30 as illustrated in FIG. 3. As can be appreciated, reinforcement mat 10 illustrated in FIG. 7 can be formed of three fabric layers 20, 30 and 40 as illustrated in FIG. 4, or can include more than three layers. These other configurations of reinforcement mat 10 are not illustrated since it will be readily understood to one skilled in the art that the feature of the reinforcement mat 10 that are illustrated and described with reference to FIG. 7 can be equally applied to a reinforcement mat 10 that is formed of three or more fabric layers. As illustrated in FIG. 7, fibers or fiber sets 22, 32 are coated with a polymer coating material 60. The polymer coating material generally includes a thermo-set or thermoplastic resin that includes a material selected from the group consisting of epoxy (e.g., Bisphenol A Epoxy Resin, Bisphenol F Epoxy Resin, Novolac Epoxy Resin, Aliphatic Epoxy Resin, Glycidylamine Epoxy Resin, etc.), polyester, vinyl ester and PEET. As can be appreciated, the thermo-set or thermoplastic resin can include other or additional materials. Generally the thermo-set or thermoplastic resin has a cure temperature of at least 140° F. and up to about 400° F.; however, thermo-set or thermoplastic resin having other cure temperatures can be used. The polymer coating material can be formed of one or more materials. The polymer coating material can be applied to the fibers or fiber sets prior and/or after the fabric layers are connected together. Generally, the polymer coating material is applied to the fibers or fiber sets after the fabric layers are connected together. The coating can be applied by dipping, spray coating and the like. As illustrated in FIG. 7, the application of the coating to the fibers or fiber sets does not result in the elimination of openings 50. The ratio of the thickness of coating 60 to the cross-section area of the fibers or fiber sets is about 0.1-100:1, typically about 0.25-50:1, and more typically about 0.5-25:1; however, other ratios can be used.

Referring again to FIG. 7, a backing material 70 is connected to fiber layer 20. As can be appreciated, backing material 70 can also or alternatively be connected to fiber layer 20. The use of backing material 70 is optional. The backing material 70 is generally connected to the fiber layer after coating 60 is applied to the fiber layers; however, this is not required. Generally the backing material does not include a coating of polymer; however, this is not required. Backing material 70 generally has a uniform thickness; however, this is not required. The backing material is generally formed of or includes a non-woven material; however, this is not required. The backing material can be connected to the fibers or fiber sets by stitching, adhesive bonding, melted or fused connection, use of one or more coatings, etc. The backing material can have a melting point that is less than the melting point of the fibers or fiber sets of the fabric layers; however, this is not required. Generally, the backing material is a nonwoven material that is formed of a polymer material that includes a material such as, but not limited to, nylon, polyester, polypropylene, polyethylene, polyurethane, poly(meth) acrylate, etc. The thickness of the backing material is non-limiting.

The reinforcement mat of the present invention is designed to form a stronger bond with the asphalt or bitumen top layer and a sub-base as compared with prior art repair systems. Referring now to FIGS. 1, 2, 5 and 6, there is illustrated one non-limiting application of the reinforcement mat of the present invention. The reinforcement mat of the present invention can be applied to a surface to be exposed to various types of traffic (e.g., pedestrian traffic, vehicle traffic, motor bike traffic, bicycle traffic, etc.). The reinforcement mat of the present invention can be used to repair such traffic surfaces and/or be used to form a more durable traffic surface. FIGS. 1, 2, 5 and 6 illustrate the reinforcement mat of the present invention being used in a road for a vehicle; however, the description of use of the reinforcement mat in FIGS. 1, 2, 5 and 6 can be used to repair and/or form other types of traffic surfaces.

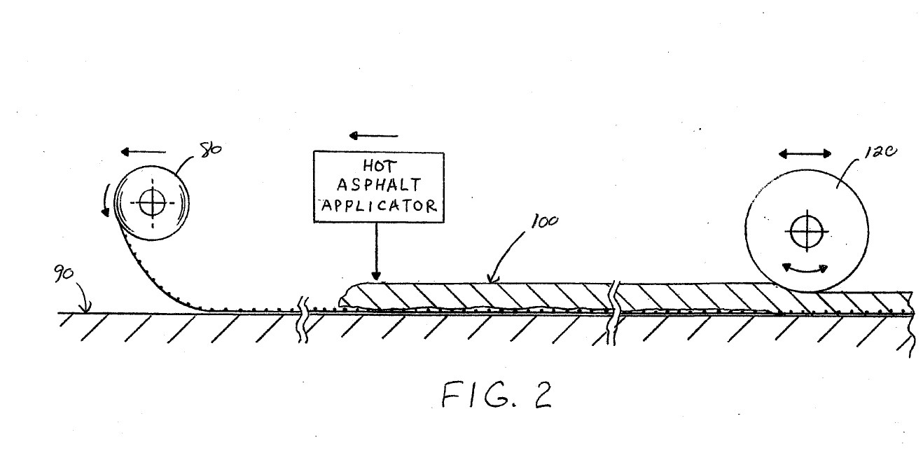

As illustrated in FIG. 2, a roll 80 of reinforcement mat 10 is laid onto a sub-base 90. The sub-base 90 can be a concrete, gravel, crushed stone, asphalt or bitumen surface, or other type of surface. The sub-base can be a preexisting or new surface. The reinforcement mat 10 is illustrated as being dispensed form a roll 80; however, this is not required. In one non-limiting arrangement, roll 80 is connected to a vehicle that slowly travels along the sub-base and slowly causes the reinforcement mat to be laid on the sub-base. The sub-base can be prepared (e.g., cleaned, scraped, fill-in pot holes, fill-in cracks, etc.) prior to the reinforcement mat being laid on the sub-base; however, this is not required. An adhesive material can be applied to the sub-base prior to and/or after the reinforcement mat is laid on the sub-base; however, this is not required. Coating 60 can be applied or an additional layer of coating 60 can be applied to the reinforcement mat and/or sub-base prior to and/or after the reinforcement mat is laid on the sub-base; however, this is not required.

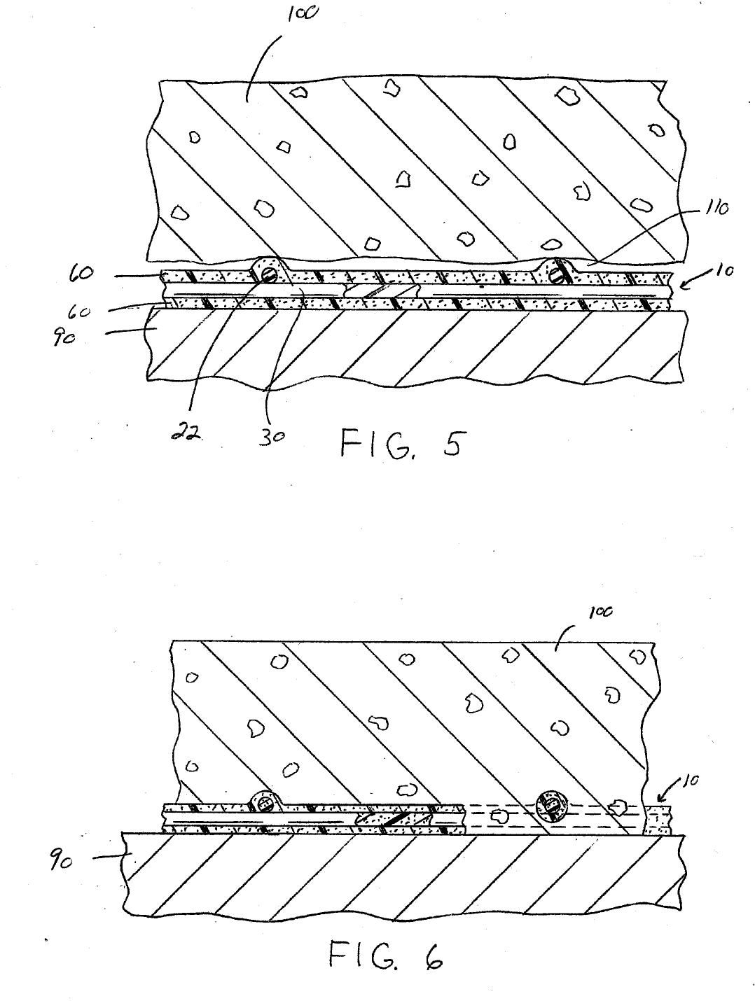

After the reinforcement mat is laid on the sub-base, a layer of asphalt or bitumen 100 or some other type of surface material (composite surface, bituminous surface, etc.) is applied to the top surface of the reinforcement mat as illustrated in FIGS. 1 and 2. Layer 100 can be applied to the top surface of the reinforcement mat by any conventional application system (e.g., dump truck, asphalt laying machine, etc.). FIG. 5 illustrates layer 100 applied to the surface of the reinforcement mat while the bottom surface of the reinforcement mat is positioned on top of sub-base 90. In FIG. 5, the layer 100 has not yet been pressed against reinforcement mat 10. As such, small spaces 110 may exist between some portions of the reinforcement mat and layer 100; however, this is not required. Layer 100 is generally placed on the top of reinforcement mat when the layer is in heated state. Generally, the temperature of layer 100 when applied to the top of reinforcement mat is generally at least about 30° F., typically at least about 45° F., more typically at least about 90° F., still more typically at least 150°, yet more typically about 150-500° F., and still yet more typically about 200-350°F. As can be appreciated, the temperature of the layer 100 can have other temperature when applied to the top of reinforcement mat. In one non-limiting method, the layer 100 is generally placed on the top of reinforcement mat when the layer is at a temperature that is the same or greater than the curing or melting temperature of coating 60. Generally the temperature of layer 100 should be high enough to cause coating 60 to become at least semi-fluid prior to or during the application of pressure on a layer that causes the reinforcement mat to be compressed between layer 100 and sub-base 90. When coating 60 becomes fluid or semi-fluid, the coating is able to partially or fully saturate the fibers or fiber sets of the reinforcement mat thereby further strengthening the reinforcement mat. Also, when coating 60 becomes fluid or semi-fluid, the coating facilitates in forming a bond with layer 100 and/or sub-base 90. Coating 60 can be a pre-catalyzed or post catalyzed coating. When the coating is a pre-catalyzed coating, the temperature of layer 100 should be high enough to cause coating 60 to begin catalyzing prior to or during the application of pressure on a layer that causes the reinforcement mat to be compressed between layer 100 and sub-base 90.

FIG. 2 illustrates a roller 120 that can be used to apply pressure on layer 100 to cause the reinforcement mat to be compressed between layer 100 and sub-base 90. The compression of layer 100 generally causes layer 100 to become thinner as illustrated in FIG. 2; however, this is not required. Also, compression of layer 100 generally causes spaces 110 to be partially or fully eliminated as illustrated in FIG. 6; however, this is not required.

When the reinforcement mat includes a backing material 70, the backing material can be used to further facilitate in the connection of the reinforcement mat to layer 100 and/or sub-base 90.

It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween. The invention has been described with reference to the preferred embodiments. These and other modifications of the preferred embodiments as well as other embodiments of the invention will be obvious from the disclosure herein, whereby the foregoing descriptive matter is to be interpreted merely as illustrative of the invention and not as a limitation. It is intended to include all such modifications and alterations insofar as they come within the scope of the appended claims.

I claim:

1. A reinforcement mat comprising a first and second layer of fiber material, each of said layers of fiber material formed of a plurality of fibers or fiber sets that are spaced apart from one another and positioned generally parallel to one another, a plurality of fibers or fiber sets of said first layer of fiber material positioned non-parallel to a plurality of fibers or fiber sets of said second layer of fiber material, said first and second layers of fiber material connected together, a plurality of fibers or fiber sets of said first layer of fiber material, a plurality of fibers or fiber sets of said second layer of fiber material, or combinations thereof are at least partially coated with a layer of resin.

2. The reinforcement mat as defined in claim 1, wherein said fibers or fiber sets are formed of a material selected from the group consisting of glass fibers, carbon fibers, quartz fibers, Kevlar® fibers, boron fibers, polyethylene fibers, polyamide fibers, polypropylene fibers.

3. The reinforcement mat as defined in claim 1, wherein said resin includes thermo-set or thermoplastic resin that includes a material selected from the group consisting of epoxy, polyester, vinyl ester and PEET.

4. The reinforcement mat as defined in claim 2, wherein said resin includes thermo-set or thermoplastic resin that includes a material selected from the group consisting of epoxy, polyester, vinyl ester and PEET.

5. The reinforcement mat as defined in claim 1, including a non-woven backing that is connected to said first layer of fiber material, said second layer of fiber material, or combinations thereof.

6. The reinforcement mat as defined in claim 4, including a non-woven backing that is connected to said first layer of fiber material, said second layer of fiber material, or combinations thereof.

7. The reinforcement mat as defined in claim 1, including a third layer of fiber material, said third layer of fiber material is formed of a plurality of fibers or fiber sets that are spaced apart from one another and positioned generally parallel to one another, a plurality of fibers or fiber sets of said third layer of fiber material positioned non-parallel to a plurality of fibers or fiber sets of said first and second layers of fiber material, said third layer of fiber material connected to said second layer of fiber material, a plurality of fibers or fiber sets of said third layer of fiber material is at least partially coated with a layer of resin.

8. The reinforcement mat as defined in claim 6, including a third layer of fiber material, said third layer of fiber material is formed of a plurality of fibers or fiber sets that are spaced apart from one another and positioned generally parallel to one another, a plurality of fibers or fiber sets of said third layer of fiber material positioned non-parallel to a plurality of fibers or fiber sets of said first and second layers of fiber material, said third layer of fiber material connected to said second layer of fiber material, a plurality of fibers or fiber sets of said third layer of fiber material is at least partially coated with a layer of resin.

9. The reinforcement mat as defined in claim 7, including a non-woven backing that is connected to said second layer of fiber material, said third layer of fiber material, or combinations thereof.

10. The reinforcement mat as defined in claim 8, including a non-woven backing that is connected to said second layer of fiber material, said third layer of fiber material, or combinations thereof.

11. A method for repairing pavement comprising the steps of:
a. applying at least one layer of a reinforcement mat onto a sub-base of a road or path or sidewalk, said sub-base including crushed stone, asphalt, bitumen, rocks, ceramic, crushed ceramic, or concrete, said reinforcement mat comprising a first and second layers of fiber material, each of said layers of fiber material formed of a plurality of fibers or fiber sets that are spaced apart from one another and positioned generally parallel to one another, a plurality of fibers or fiber sets of said first layer of fiber material positioned non-parallel to a plurality of fibers or fiber sets of said second layer of fiber material, said first and second layers of fiber material connected together, a plurality of fibers or fiber sets of said first layer of fiber material, a plurality of fibers or fiber sets of said second layer of fiber material, or combinations thereof are at least partially coated with a layer of resin; and,
b. applying at least one layer of asphalt or bitumen material on top of said at least one layer of said reinforcement mat, said asphalt or bitumen material having a temperature of at least about 45° F.

12. The method as defined in claim 11, further including the step of:
c. applying a compressive pressure to said at least one layer of asphalt or bitumen material to compress said at least one layer of said asphalt or bitumen material onto said at least one layer of said reinforcement mat to cause said resin to at least partially melt and form a bond between said at least one layer of a reinforcement mat and said sub-base and said at least one layer of a reinforcement mat and said applied asphalt or bitumen material layer.

13. The method as defined in claim 11, wherein said fibers or fiber sets are formed of a material selected from the group consisting of glass fibers, carbon fibers, quartz fibers, Kevlar® fibers, boron fibers, polyethylene fibers, polyamide fibers, polypropylene fibers.

14. The method as defined in claim 12, wherein said fibers or fiber sets are formed of a material selected from the group consisting of glass fibers, carbon fibers, quartz fibers, Kevlar® fibers, boron fibers, polyethylene fibers, polyamide fibers, polypropylene fibers.

15. The method as defined in claim 11, wherein said resin includes thermo-set or thermoplastic resin that includes a material selected from the group consisting of epoxy, polyester, vinyl ester and PEET.

16. The method as defined in claim 14, wherein said resin includes thermo-set or thermoplastic resin that includes a material selected from the group consisting of epoxy, polyester, vinyl ester and PEET.

17. The method as defined in claim 11, including a non-woven backing that is connected to said first layer of fiber material, said second layer of fiber material, or combinations thereof.

18. The method as defined in claim 16, including a non-woven backing that is connected to said first layer of fiber material, said second layer of fiber material, or combinations thereof.

19. The method as defined in claim 11, including a third layer of fiber material, said third layer of fiber material is formed of a plurality of fibers or fiber sets that are spaced apart from one another and positioned generally parallel to one another, a plurality of fibers or fiber sets of said third layer of fiber material positioned non-parallel to a plurality of fibers or fiber sets of said first and second layers of fiber material, said third layer of fiber material connected to said second layer of fiber material, a plurality of fibers or fiber sets of said third layer of fiber material is at least partially coated with a layer of resin.

20. The method as defined in claim 18, including a third layer of fiber material, said third layer of fiber material is formed of a plurality of fibers or fiber sets that are spaced apart from one another and positioned generally parallel to one another, a plurality of fibers or fiber sets of said third layer of fiber material positioned non-parallel to a plurality of fibers or fiber sets of said first and second layers of fiber material, said third layer of fiber material connected to said second layer of fiber material, a plurality of fibers or fiber sets of said third layer of fiber material is at least partially coated with a layer of resin.

21. The method as defined in claim 19, including a non-woven backing that is connected to said second layer of fiber material, said third layer of fiber material, or combinations thereof.

22. The reinforcement mat as defined in claim 20, including a non-woven backing that is connected to said second layer of fiber material, said third layer of fiber material, or combinations thereof.
